(19) United States
(12) Patent Application Publication
(10) Pub. No.: US 2016/0069481 A1
(43) Pub. Date: Mar. 10, 2016

(54) FEED-CABLE RETAINING STRUCTURE AND IMAGE FORMING APPARATUS INCLUDING THE SAME

(71) Applicant: FUJI XEROX Co., Ltd., Tokyo (JP)

(72) Inventors: Misa HISHIDA, Kanagawa (JP); Masahiro MORI, Kanagawa (JP)

(73) Assignee: FUJI XEROX Co., Ltd., Tokyo (JP)

(21) Appl. No.: 14/617,513

(22) Filed: Feb. 9, 2015

(30) Foreign Application Priority Data
Sep. 4, 2014 (JP) 2014-180557

(51) Int. Cl. F16L 3/10

(52) U.S. Cl. CPC F16L 3/1066; G03G 15/80; F16L 3/10; F16L 3/20

(57) ABSTRACT

A feed-cable retaining structure retains a feed cable that supplies electric power. The feed-cable retaining structure includes a support member, retaining members, and an adjusting member. The support member supports the feed cable in an insulating manner. The retaining members support the feed cable in an insulating manner at predetermined positions along a longitudinal direction of the feed cable. Each retaining member includes two or more elements that retain the feed cable so as to sandwich the feed cable in a width direction. The adjusting member is located at a position shifted from a middle point between the adjacent retaining members toward one of the adjacent retaining members, the position including a position of the one of the adjacent retaining members, and adjusts an insulating gap between the feed cable and the support member by separating the feed cable from the support member.

### CROSS-REFERENCE TO RELATED APPLICATIONS

This application is based on and claims priority under 35 USC 119 from Japanese Patent Application No. 2014-180557 filed Sep. 4, 2014.

### BACKGROUND

### Technical Field

The present invention relates to a feed-cable retaining structure and an image forming apparatus including the feed-cable retaining structure.

### SUMMARY

According to an aspect of the invention, there is provided a feed-cable retaining structure that retains a feed cable that supplies electric power including an alternating current component from a power supply to a power receiving member, the feed-cable retaining structure including a support member that supports the feed cable in an insulating manner; plural retaining members that support the feed cable above the support member in an insulating manner at plural predetermined positions along a longitudinal direction of the feed cable, each retaining member including two or more elements that retain the feed cable so as to sandwich the feed cable in a width direction; and an adjusting member located at a position shifted from a middle point between the adjacent retaining members on the support member toward one of the adjacent retaining members, the position including a position of the one of the adjacent retaining members, the adjusting member adjusting an insulating gap between the feed cable and the support member by separating the feed cable from the support member.

### BRIEF DESCRIPTION OF THE DRAWINGS

An exemplary embodiment of the present invention will be described in detail based on the following figures, wherein:

FIGS. 1A and 1B illustrate the outline of a feed-cable retaining structure according to an exemplary embodiment to which the present invention is applied;

FIG. 2A illustrates the operation of the feed-cable retaining structure according to the exemplary embodiment;

FIG. 2B illustrates the operation of a feed-cable retaining structure according to a comparative example;

FIGS. 3A and 3B illustrate two types of structures of a retaining member;

FIG. 4 illustrates an image forming apparatus according to the exemplary embodiment to which the present invention is applied;

FIG. 5 illustrates a portion of a feed-cable retaining structure according to the exemplary embodiment;

FIG. 6A is a plan view of part VIA in FIG. 5;

FIG. 6B illustrates part VIA in FIG. 5 viewed in the direction of arrow VIB in FIG. 6A;

FIG. 7 is a perspective view of frame members;

FIG. 8 is a perspective view illustrating the positional relationship between the frame members and other members;

FIGS. 9A and 9C illustrate feed-cable retaining structures according to modifications that differ from the exemplary embodiment;

FIG. 9B illustrates the structure of FIG. 9A viewed in the direction of arrow IXB; and

FIG. 9D illustrates the feed-cable retaining structure of FIG. 9C viewed in the direction of arrow IXD.

### DETAILED DESCRIPTION

### Outline of Exemplary Embodiment

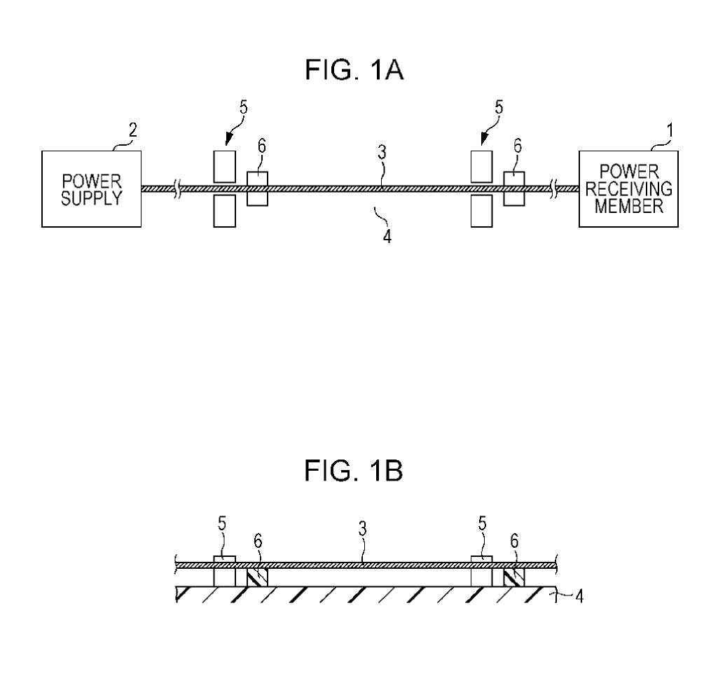

FIGS. 1A and 1B illustrate the outline of a feed-cable retaining structure according to an exemplary embodiment to which the present invention is applied. FIG. 1A illustrates the feed-cable retaining structure, and FIG. 1B is a sectional view of FIG. 1A taken along a feed cable 3.

Referring to FIGS. 1A and 1B, the feed-cable retaining structure retains the feed cable 3 that supplies electric power including an alternating current component from a power supply 2 to a power receiving member 1. The feed-cable retaining structure includes a support member 4, retaining members 5, and adjusting members 6. The support member 4 supports the feed cable 3 in an insulating manner. Each retaining member 5 supports the feed cable 3 above the support member 4 in an insulating manner at plural predetermined positions along the longitudinal direction of the feed cable 3, and includes two or more elements that retain the feed cable 3 so as to sandwich the feed cable 3 in a width direction. Each adjusting member 6 is located at a position shifted from the middle point between the adjacent retaining members 5 on the support member 4 toward one of the adjacent retaining members 5, the position including the position of the one of the adjacent retaining members 5. Each adjusting member 6 adjusts an insulating gap between the feed cable 3 and the support member 4 by separating the feed cable 3 from the support member 4.

In this technical structure, the method for connecting the feed cable 3 to the power receiving member 1 and the power supply 2 is not particularly limited, and a known method may be used. With regard to the connection between the feed cable 3 and the power receiving member 1, one end of the feed cable 3 may be formed in a shape of, for example, a coil spring to improve the fitting performance of the power receiving member 1. The feed cable 3 is not particularly limited as long as the feed cable 3 is electrically connected to the power receiving member 1 and the power supply 2, and a portion of the feed cable 3 other than the connecting portions may either be a bare wire or a coated cable. The cross sectional shape of the feed cable 3 may be, for example, a circular shape or a rectangular shape. The width direction of the feed cable 3 means a direction that crosses the longitudinal direction of the feed cable 3.

In this feed-cable retaining structure, the feed cable 3 is retained by the retaining members 5, and the insulating gap is provided between the feed cable 3 and the support member 4 by the adjusting members 6. The expression “the support member 4 that supports the feed cable 3 in an insulating manner, the retaining members 5 that retain the feed cable 3 in an insulating manner, and the adjusting members 6 that adjust the insulating gap” is used to clarify that the support member 4, the retaining members 5, and the adjusting members 6 each have an insulating performance with respect to the feed cable 3, that is, are electrically insulated from the feed cable 3. Such an insulating performance is provided when, for example, the volume resistivity is 10⁹ Ω·cm or more. The materials of the support member 4, the retaining members 5, and the adjusting members 6 may be, for example, a thermoplastic resin. These members are generally produced by injection molding.

Although the support member 4, the retaining members 5, and the adjusting members 6 may be easily manufactured when they are made of the same material, they may be made of different materials. The materials are not limited to resin materials as long as the volume resistivity thereof is high.

The retaining members 5 are not particularly limited as long as each retaining member 5 includes two or more elements that sandwich the feed cable 3 in the width direction, and each retaining member 5 may include three or more elements. The adjusting members 6 may be located near the retaining members 5 or at, for example, the positions of the retaining members 5. The adjusting members 6 may be arranged such that a single adjusting member 6 is provided for each retaining member 5, or such that plural adjusting members 6 are provided for each retaining member 5. The insulating gap between the feed cable 3 and the support member 4 adjusted by the adjusting members 6 may be large, but is generally not limited as long as the insulating gap is 1 mm or more.

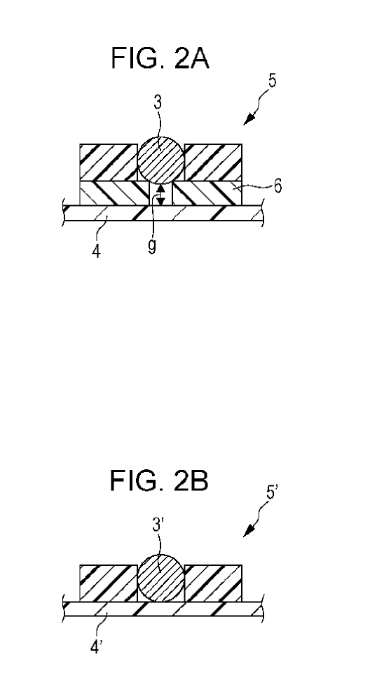

The operation of the feed-cable retaining structure will be described with reference to the sectional views of FIGS. 2A and 2B. FIG. 2A illustrates the exemplary embodiment (the adjusting member 6 is divided into segments to facilitate understanding). FIG. 2B illustrates a comparative example.

First, the comparative example illustrated in FIG. 2B will be described. In this example, a retaining member 5′ is formed on a support member 4′ (generally by forming projections together with the support member 4′). The retaining member 5′ retains a feed cable 3′ by clamping the feed cable 3′. In this case, the feed cable 3′ is retained while being pressed against and in contact with the surface of the support member 4′. Electric power including a high-voltage alternating current component (for example, 2 kVpp) is supplied to the feed cable 3′. Since the distance between the feed cable 3′ and the support member 4′ is small, the intensity of an electric field applied between the feed cable 3′ and the support member 4′ is extremely high. Therefore, a large amount of induction charge is generated in the support member 4′. As a result, a strong vibration of the feed cable 3 occurs and high-frequency sound is generated. The high-voltage alternating current component has a voltage of, for example, 1 kVpp or more.

In contrast, in the exemplary embodiment illustrated in FIG. 2A, the adjusting member 6 is provided to adjust the insulting gap between the feed cable 3 and the surface of the support member 4. Therefore, the gap g is provided between the feed cable 3 and the support member 4, and the intensity of the electric field applied between the feed cable 3 and the support member 4 is smaller than that in FIG. 2B. Accordingly, the amount of induction charge in the support member 4 is small, and generation of vibration of the feed cable 3 may be suppressed. As a result, generation of high-frequency sound may also be suppressed.

Next, a representative example of the present exemplary embodiment will be described in more detail with reference to FIGS. 1A and 1B.

Although the elements of the retaining members 5 may include portions that project toward the feed cable 3, to reliably provide the insulting gap adjusted by the adjusting members 6, the adjusting members 6 may include portions that are closer to a region in which the feed cable 3 is arranged than the elements of the retaining members 5 are.

To facilitate the manufacture of the retaining members 5 and the adjusting members 6 and control of vibration of the feed cable 3, the retaining members 5 may be formed integrally with the respective adjusting members 6.

To reduce the load placed on the feed cable 3 and retain the feed cable 3 in a stable manner at the same time, each retaining member 5 may include three or more elements that press the feed cable 3 in different directions alternately from both sides in the width direction. Although the intervals between the elements of each retaining member 5 are not particularly limited, from the viewpoint of feed-cable retaining performance and work efficiency, the elements may be arranged at intervals of 5 to 20 mm. The feed cable 3 may be easily retained when each retaining member 5 includes three elements.

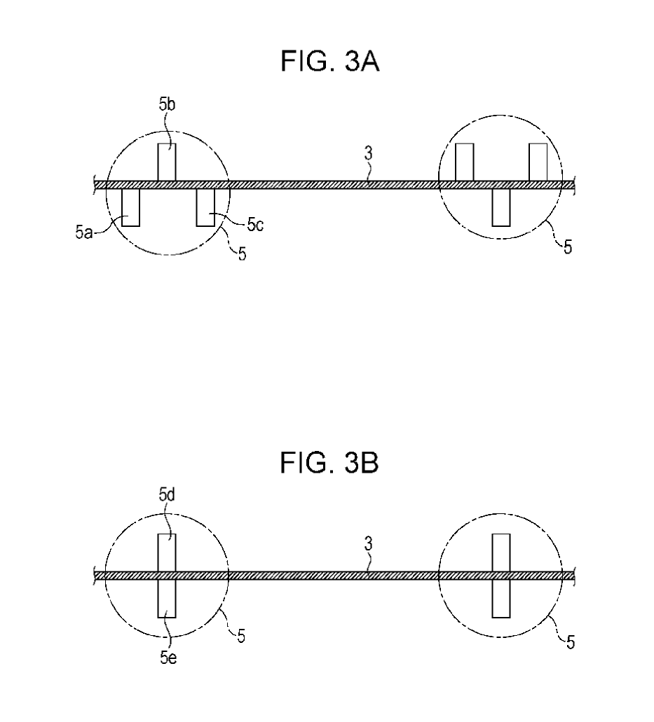

The number of elements of each retaining member 5 will now be described. FIGS. 3A and 3B are diagrams for describing the elements of each retaining member 5. FIG. 3A illustrates an example in which each retaining member 5 includes three elements 5a to 5c, and FIG. 3B illustrates an example in which each retaining member 5 includes two elements 5d and 5e.

As illustrated in FIG. 3B, when each retaining member 5 includes the two elements 5d and 5e that face each other with the feed cable 3 interposed therebetween, the feed cable 3 is generally inserted into a space between the two elements 5d and 5e while being pressed against the two elements 5d and 5e. Therefore, the two elements 5d and 5e are easily buckled owing to the inserted feed cable 3. As a result, the feed cable 3 tends to receive a force in a direction toward the near side in FIG. 3B, that is, in a direction opposite to the insertion direction. Accordingly, the retaining force applied to the feed cable 3 is reduced, and the feed cable 3 is easily removed from the retaining position.

In contrast, as illustrated in FIG. 3A, when each retaining member 5 includes the three elements 5a to 5c, the feed cable 3 may be attached to the retaining member 5 by being bent substantially in a V-shape. The feed cable 3 is pressed by the three elements 5a to 5c alternately in different directions. Therefore, the feed cable 3 does not easily receive the force described above with reference to FIG. 3B, that is, the force in the direction toward the near side in FIG. 3B, and is retained in a stable manner.

Although the distances between the three elements 5a to 5c are not particularly limited, to improve the feed-cable retaining performance and facilitate attachment of the feed cable 3, the three elements 5a to 5c may be arranged at intervals of 5 to 20 mm. Also, to reduce the load placed on the feed cable 3 in the longitudinal direction, each retaining member 5 may include three elements that retain the feed cable 3 so as to sandwich the feed cable 3 alternately from both sides in the width direction, and, among the retaining members 5, two retaining members 5 that are adjacent to each other in the longitudinal direction of the feed cable 3 may be arranged such that the positional relationship between one of the three elements and the remaining two of the three elements is inverted between the two retaining members 5. More specifically, as illustrated in FIG. 3A, the adjacent retaining members 5 may be arranged such that the number of elements disposed on each side of the feed cable 3 is two for one of the retaining members 5 and one for the other retaining member 5.

An image forming apparatus including the above-described feed-cable retaining structure will now be described. Referring to FIG. 1A, the image forming apparatus includes an image forming unit (not shown) including the power supply 2 and the power receiving member 1 that receives electric power from the power supply 2 to form an image; and the above-described feed-cable retaining structure provided between the power supply 2 and the power receiving member 1. The power receiving member 1 may be any component of the image forming unit that uses the electric power including a high-voltage alternating current component. More specifically, the power receiving member 1 may be, for example, a charging member, a developing member, a transferring member, a cleaning member, or an electricity removing member. The feed cable 3 and the power receiving member 1 may be connected to each other by a coil spring, a leaf spring, etc., as long as an electrical connection is provided therebetween.

The exemplary embodiment of the present invention illustrated in the drawings will now be described in more detail.

### Exemplary Embodiment

### Overall Structure of Image Forming Apparatus

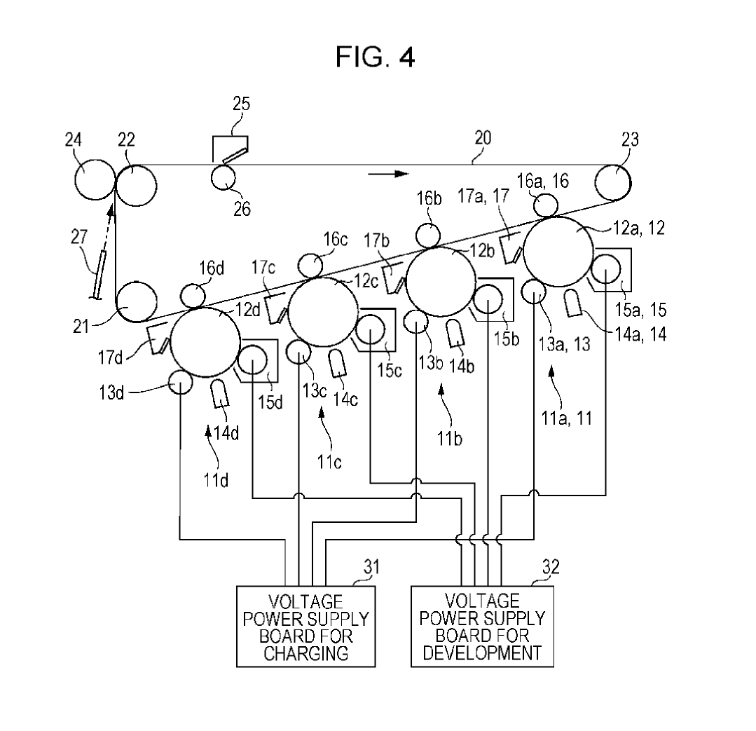

FIG. 4 illustrates the outline of an image forming apparatus according to the exemplary embodiment of the present invention.

Referring to FIG. 4, the image forming apparatus includes four image forming units 11 (more specifically, 11a to 11d) for respective colors (for example, black, yellow, magenta, and cyan) that are arranged horizontally, and an intermediate transfer belt 20 disposed above the image forming units 11. The intermediate transfer belt 20 rotates along the array of the image forming units 11 in the direction shown by the arrow.

Each image forming unit 11 forms a toner image of the corresponding color on the intermediate transfer belt 20, and includes a photoconductor 12 (more specifically, 12a to 12d) including a photosensitive layer. Various devices for forming the toner image are arranged around the photoconductor 12. The devices include a charging device 13 (more specifically, 13a to 13d) that charges the photoconductor 12 to a predetermined potential in advance; an exposure device 14 (more specifically, 14a to 14d) that performs an exposure process for forming a latent image on the charged photoconductor 12; and a developing device 15 (more specifically, 15a to 15d) that develops the latent image on the photoconductor 12 with toner. In addition, a transfer device 16 (more specifically, 16a to 16d) is disposed so as to face the photoconductor 12 with the intermediate transfer belt 20 interposed therebetween. The transfer device 16 transfers the developed toner image on the photoconductor 12 onto the intermediate transfer belt 20. A cleaning device 17 (more specifically, 17a to 17d) cleans the photoconductor 12 after the transferring process.

The intermediate transfer belt 20 rotates while being stretched around three stretching rollers 21 to 23. The stretching roller 21, for example, serves as a driving roller for rotating the intermediate transfer belt 20. A second transfer device 24 is disposed so as to face the stretching roller 22 with the intermediate transfer belt 20 interposed therebetween. The second transfer device 24 simultaneously transfers toner images onto a recording medium 27 by using the stretching roller 22 as a back-up roller, the toner images having been successively transferred from the respective image forming units 11 (11a to 11d) and superposed on the intermediate transfer belt 20. A belt cleaner 25, which cleans the intermediate transfer belt 20 after the simultaneous transferring process by the second transfer device 24, is disposed around the intermediate transfer belt 20. A counter roller 26 for ensuring sufficient cleaning performance is disposed so as to face the belt cleaner 25 with the intermediate transfer belt 20 interposed therebetween. The toner images that have been transferred to the recording medium 27 are fixed by a fixing device (not shown), and then the recording medium 27 is ejected from the image forming apparatus.

In the present exemplary embodiment, a high-voltage power supply board 31 for charging is connected to each of the charging devices 13 (13a to 13d) included in the image forming units 11, and a high-voltage power supply board 32 for development is connected to each of the developing devices 15 (15a to 15d) included in the image forming units 11. Feed cables are arranged to electrically connect the charging devices 13 and the developing devices 15 to the two high-voltage power supply boards 31 and 32. Thus, in the present exemplary embodiment, the two high-voltage power supply boards 31 and 32 correspond to power supplies, and the charging devices 13 and the developing devices 15 correspond to power receiving members. Accordingly, a feed-cable retaining structure 40 for retaining the feed cables is provided between the high-voltage power supply board 31 and the charging devices 13 and between the high-voltage power supply board 32 and the developing devices 15. In the present exemplary embodiment, the high-voltage power supply board 31 for charging uses a high voltage of, for example, 2 kVpp in which a direct current is superimposed, and the high-voltage power supply board 32 for development uses a high voltage of, for example, 1.5 kVpp in which a direct current is superimposed. These high voltages are examples, and are not limited as long as a high-voltage alternating current component is included.

### Configuration of Feed-Cable Retaining Structure

The feed-cable retaining structure 40 according to the present exemplary embodiment retains feed cables between the high-voltage power supply board 31 and the charging devices 13 (more specifically, 13a to 13d) and between the high-voltage power supply board 32 and the developing devices 15 (more specifically, 15a to 15d). The feed cables are retained by frame members (not shown), which serve as support members and are formed by resin molding.

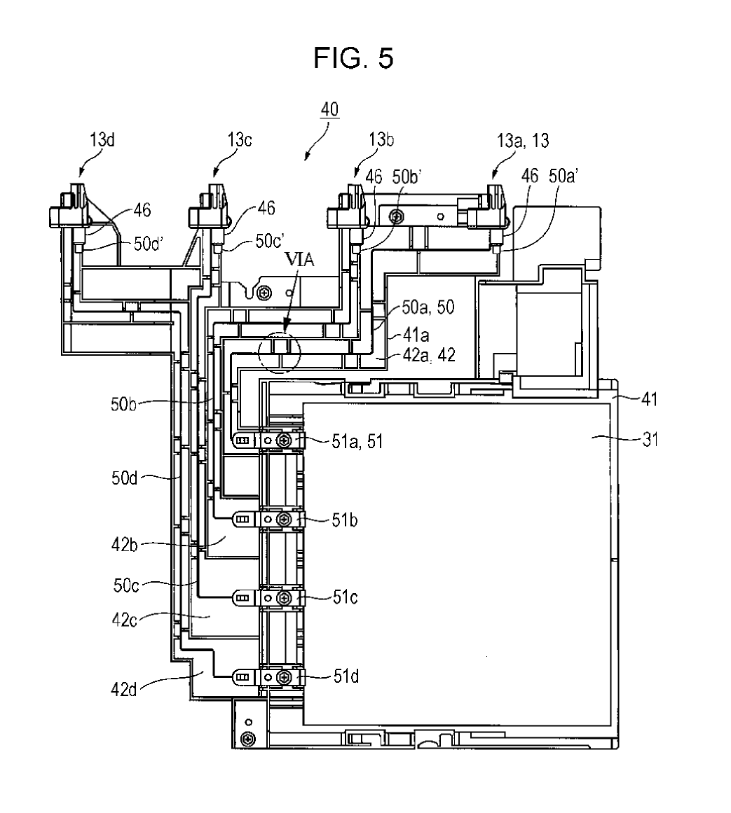

FIG. 5 illustrates a portion of the feed-cable retaining structure 40 according to the present exemplary embodiment, more specifically, a portion of the feed-cable retaining structure 40 between the high-voltage power supply board 31 for charging (formed as a printed circuit board) and the charging devices 13a to 13d (parts shown by the dashed arrows in FIG. 5). In this example, a frame member 41 (charging frame member 41α described below to be exact, but simply referred to as frame member here), which serves as a support member, is formed by injection molding by using a flame-retardant ABS resin. However, the frame member 41 is not limited to this as long as it is made of an insulating material (material having a volume resistivity of 10⁹ Ω·cm or more) and the feeding performance is not degraded. For example, the frame member 41 may be formed of a glass-reinforced resin or a modified PPE resin. The high-voltage power supply board 31 for charging is mounted on the frame member 41 by, for example, fastening screws, and is electrically connected to the charging devices 13a to 13d by feed cables 50 (more specifically, 50a to 50d).

Bosses used to mount the high-voltage power supply board 31 on the frame member 41 are formed on the frame member 41. In addition, ribs 41a that project along the feed cables 50 are provided on the frame member 41, and grooves 42 (more specifically, 42a to 42d) are formed in regions between the ribs 41a. The feed cables 50 for supplying the electric power from the high-voltage power supply board 31 to the charging devices 13a to 13d are retained in the grooves. Since the ribs 41a are provided, the feed cables 50 may be easily arranged and the strength of the frame member 41 itself may be increased. In the present exemplary embodiment, the frame member 41 includes a standing portion that stands at a position near the charging device 13. This structure may be provided by, for example, employing an additional molded part. The feed cables 50 are connected to the charging devices 13 through the standing portion.

The feed cables 50a to 50d according to the present exemplary embodiment are stainless steel wires for springs (for example, SUS304WPA), and are bent a certain number of times along the grooves 42 on the frame member 41 to provide electrical connection between the high-voltage power supply board 31 and the charging devices 13a to 13d. In addition, in the present exemplary embodiment, end portions of the feed cables 50a to 50d near the respective charging devices 13 (portions denoted by 50a′ to 50d′ in FIG. 5) are wound in a coil shape, and the coil-shaped end portions partially project from ends of respective sleeves 46. In other words, each feed cable 50 is coil-shaped at one end thereof, and is electrically connected to the corresponding charging device (more specifically, charging roller) 13 through the coil-spring-shaped end portion.

The other end portions of the feed cables 50a to 50d are provided with respective contact springs 51 (more specifically, 51a to 51d) that are attached to the frame member 41 so as to press the high-voltage power supply board 31 to provide an electrical connection to the high-voltage power supply board 31. The contact springs 51 are connected to the respective feed cables 50 by crimping. When the contact springs 51 are fastened to the frame member 41 with screws, the contact springs 51 provide electrical connection to respective connecting portions of the high-voltage power supply board 31. Portions of the contact springs 51 that extend toward the grooves 42 on the frame member 41 are retained so as to be separated from the bottom of the grooves 42 by about 1 mm. Thus, gaps are provided between the feed cables 50 and the bottom of the grooves 42 in these regions.

Next, the specific manner in which each feed cable 50 is retained in the present exemplary embodiment will be described. Part VIA illustrated in FIG. 5 (hereinafter referred to as part VIA) corresponds to a retaining member according to the present exemplary embodiment, and the retaining member retains the corresponding feed cable 50 in a stable manner. In the present exemplary embodiment, portions that retain the feed cables 50 in the grooves 42 on the frame member 41 have substantially the same structure. Therefore, part VIA will be described in detail.

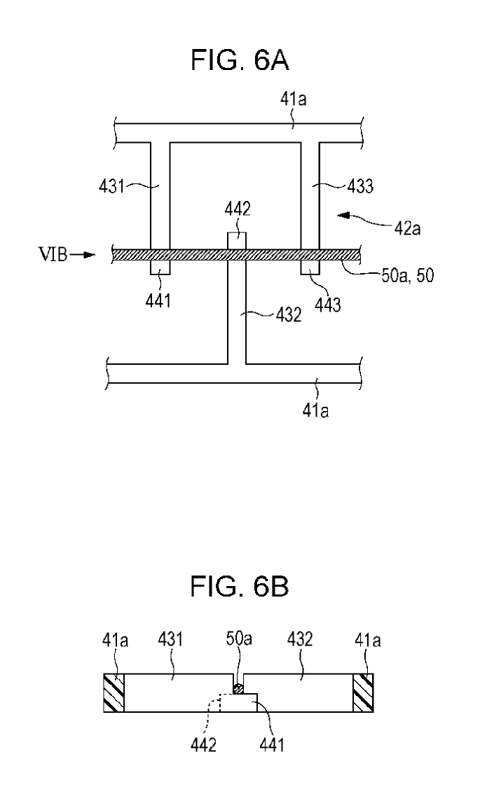

FIG. 6A is a plan view of part VIA. FIG. 6B illustrates part VIA viewed in the direction of arrow VIB in FIG. 6A. In the present exemplary embodiment, each groove 42a is formed by forming the ribs 41a on a portion of the frame member 41 (not shown). Three projecting portions 431 to 433 are formed in the groove 42a so as to project toward the ribs 41a that oppose each other. The projecting portions 431 to 433 correspond to the three elements of each retaining member that retains the feed cable 50a in an insulating manner in the present exemplary embodiment. In part VIA, which is a region in which the feed cable 50a is retained in the present exemplary embodiment, the three projecting portions 431 to 433 are arranged at intervals of about 5 mm. The mounted feed cable 50a is sandwiched by the three projecting portions 431 to 433 and retained such that the feed cable 50a is pressed toward the ribs 41a that oppose each other. Owing to this and the rigidity of the feed cable 50a itself, the feed cable 50a receives forces in opposite directions toward the center of the groove 42a in regions between the projecting portions 431 to 433 that are adjacent to each other. Thus, the feed cable 50a is retained by the three projecting portions 431 to 433, which correspond to the three elements of each retaining member, in a more stable manner.

The feed cable 50a may be mounted to the projecting portions 431 to 433 simply by pressing the feed cable 50a toward the bottom of the groove 42a, and this may be easily achieved. In addition, the feed cable 50a retained by the projecting portions 431 to 433 receives forces in directions toward the ribs 41a (directions substantially parallel to the bottom of the groove 42a), and is not easily removed from the region in which the feed cable 50a is retained once the feed cable 50a is retained. If two projecting portions (not shown) are provided at positions that oppose each other with the feed cable 50a provided therebetween, the feed cable is to be pressed into the region between the two projecting portions. In this case, the projecting portions themselves are easily deformed, and the mounted feed cable tends to receive a force in a direction in which the feed cable is released from the retained state (force in a direction opposite to the direction of the pressing force applied to the feed cable).

In the present exemplary embodiment, adjusting portions 441 to 443 are formed on end portions of the three projecting portions 431 to 433 (end portions that extend toward the opposing ribs 41a). The adjusting portions 441 to 443 are shorter than the projecting portions 431 to 433 and are closer to the region in which the feed cable 50a is arranged than the projecting portions 431 to 433 are. These adjusting portions 441 to 443 are provided to prevent the feed cable 50a retained by the projecting portions 431 to 433 from coming into direct contact with the bottom of the groove 42a, and have a height of about 1 mm from the bottom of the groove 42a. Thus, in the present exemplary embodiment, the adjusting portions 441 to 443 correspond to the adjusting members that adjust the insulating gap between the feed cable 50a and the bottom of the groove 42a.

In the present exemplary embodiment, since the adjusting portions 441 to 443 are provided, even when the electric power including a high-voltage alternating current component is supplied through the feed cable 50a, an air gap having a size corresponding to the height of the adjusting portions 441 to 443 is provided between the feed cable 50a and the bottom of the groove 42a. Therefore, the induction charge from the feed cable 50a in the groove 42a is small, and the intensity of an electric field applied between the feed cable 50a and the groove 42a is also small. As a result, vibration of the feed cable 50a itself due to the electric field generated around the feed cable 50a is reduced, and generation of high-frequency sound is suppressed. If the feed cable 50a comes into direct contact with the bottom of the groove 42a, the intensity of the electric field applied between the feed cable 50a and the groove 42a is increased, and vibration of the feed cable 50a itself is increased accordingly. As a result, high-frequency sound is generated. In the present exemplary embodiment, the distance between the three projecting portions 431 to 433, which correspond to the three elements of each retaining member, and three projecting portions of a retaining member adjacent thereto is, of course, set such that resonance does not occur at a frequency of the electric power supplied through the feed cable 50a.

The projecting portions 431 to 433 and the adjusting portions 441 to 443 according to the present exemplary embodiment are formed together with the ribs 41a when the frame member 41 is formed by injection molding, and therefore may be easily produced. Although the three projecting portions 431 to 433 are arranged at intervals of 5 mm in the present exemplary embodiment, the intervals are not particularly limited as long as the feed cable 50a may be retained. However, to facilitate mounting of the feed cable 50a and retain the feed cable 50a in a stable manner, the intervals may be set to 5 to 20 mm. It is not necessary that the intervals between the three projecting portions 431 to 433 be constant over the entire region of the frame member 41, and may be varied. In addition, the retaining member including the three projecting portions 431 to 433 may be spaced from the retaining members adjacent thereto by different distances as long as the retaining members are arranged such that the feed cable 50a may be retained.

In addition, in the present exemplary embodiment, the height of the adjusting portions 441 to 443, that is, the insulating gap between the feed cable 50a and the bottom of the groove 42a, is set to about 1 mm. However, the insulating gap is not limited to this, and may be increased to reduce the influence of the electric field. The insulating gap may be 1 mm or more, and generally 4 mm at a maximum in consideration of the size of the resin molded product, reduction in size of the frame member 41, and reliable formation of the gap. In addition, in the present exemplary embodiment, the three projecting portions 431 to 433 are all provided with the respective adjusting portions 441 to 443. However, the arrangement of the adjusting portions is not limited to this, and may be such that, for example, only the projecting portion 432 at the center may be provided with the adjusting portion 442 as long as the feed cable 50a does not come into contact with the bottom of the groove 42a.

In addition, in the present exemplary embodiment, as illustrated in FIG. 5, each of the retaining members adjacent to the retaining member in part VIA is arranged such that the positional relationship between one of the three projecting portions and the remaining two of the three projecting portions is inverted with respect to that of the retaining member in part VIA. Therefore, the feed cable 50a receives a uniform force in the longitudinal direction, and therefore may be retained in a more stable manner.

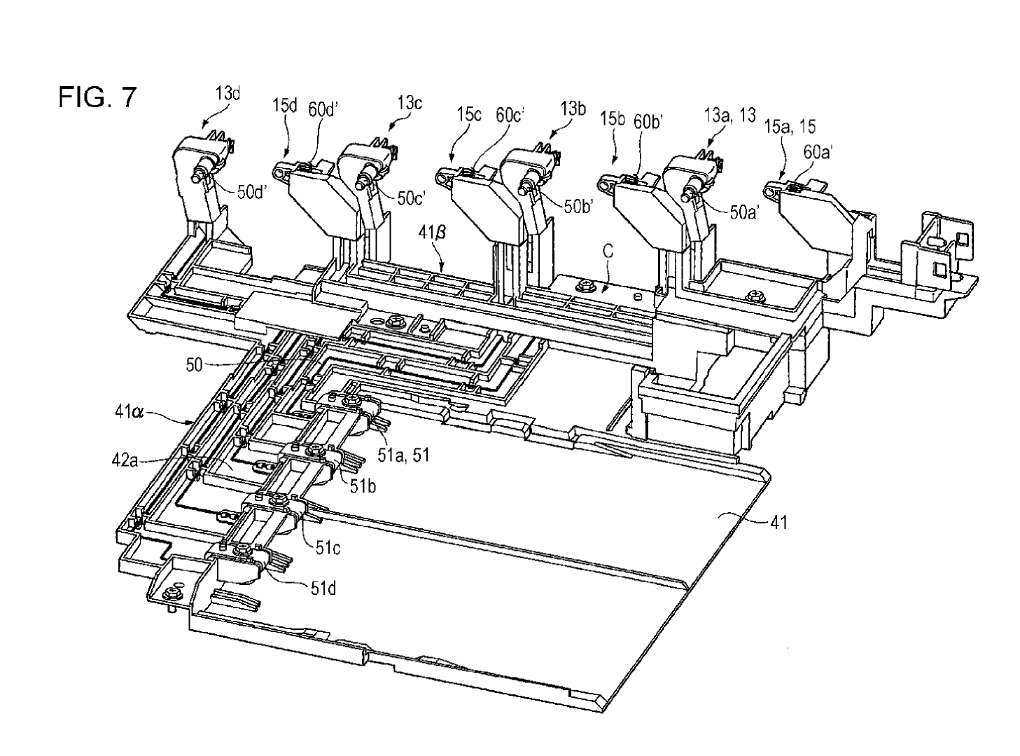

Next, frame members 41 according to the present exemplary embodiment will be described. FIG. 7 is a perspective view of the frame members 41. A developing frame member 41β is mounted so as to partially overlap the charging frame member 41α. Similar to the charging frame member 41α, which has the grooves 42a in which the feed cables 50 are held, the developing frame member 41β also has grooves in which feed cables are held. The feed cables include coil springs 60a′ to 60d′ at ends thereof so that the feed cables are electrically connected to rotating shafts included in the developing devices 15 (developing rollers in this example) through the developing frame member 41β. The other ends of the feed cables are connected to a module C illustrated in FIG. 7 so as to be connected to the high-voltage power supply board 32 for development (not shown).

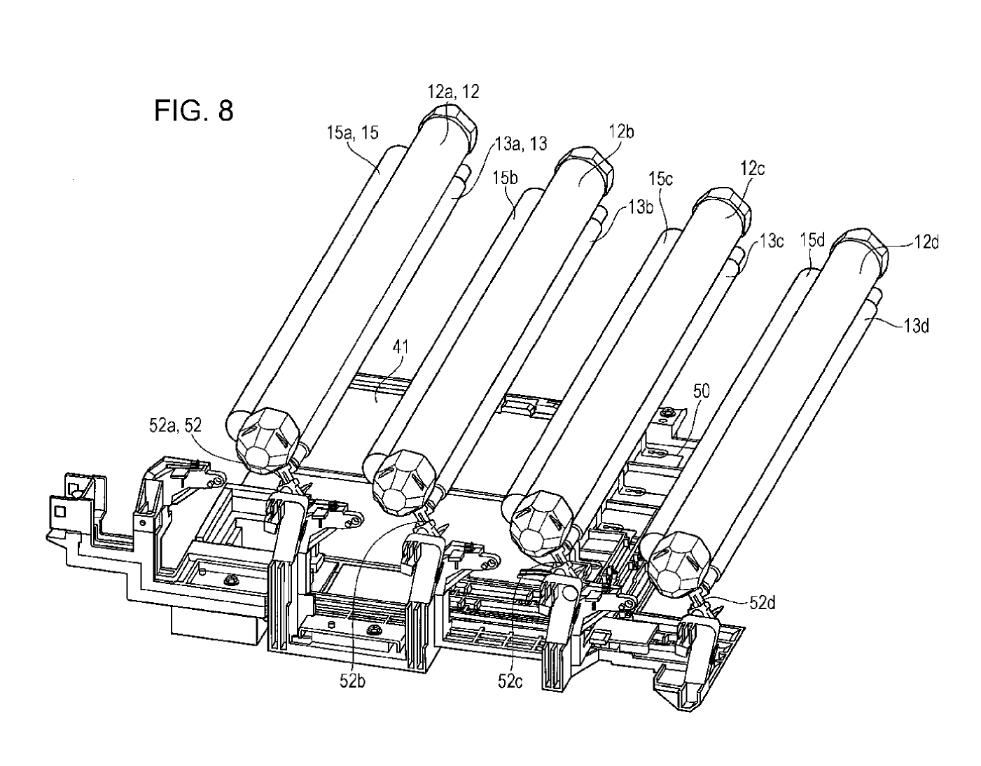

FIG. 8 is a perspective view illustrating the positional relationship between the frame members 41 and other members, viewed from the rear side of the image forming apparatus. In FIG. 8, the other members include the photoconductors 12 (12a to 12d), the charging devices (charging rollers) 13 (13a to 13d), and the developing devices (developing rollers) 15 (15a to 15d). Here, connecting members 52 (more specifically, 52a to 52d) electrically connect the coil springs 50a′ to 50d′ (see FIG. 7) provided at the ends of the feed cables 50 to the respective charging devices 13 (13a to 13d). When the charging devices 13 are mounted, stable connection is provided owing to the pressure applied by the coil springs 50a′ to 50d′. The photoconductors 12, the charging devices 13, the developing devices 15, etc., are inserted and extracted as units.

In the present exemplary embodiment, the feed-cable retaining structure holds the feed cables 50 that supply electric power to the charging devices 13 and the developing devices 15. However, portions to which the feed-cable retaining structure may be applied are not limited to this, and a similar structure may be employed for portions to which electric power including a high-voltage alternating current component is supplied. In addition, although the coil springs are formed at the ends of the feed cables 50 in the present exemplary embodiment, the spring members are not limited to coil springs, and other spring members may instead be provided. Alternatively, the feed cables 50 may be free from the coil springs, and the charging devices 13 and the developing devices 15 may be provided with spring structures. Furthermore, although the feed cables 50 are made of stainless steel wires for springs, the feed cables 50 may instead be made of other materials for springs, such as phosphor bronze or beryllium copper. In the case where the feed cables 50 are not required to have spring characteristics, other appropriate materials may be used. The material of the feed cables 50 is not limited as long as certain rigidity may be provided.

### Modifications

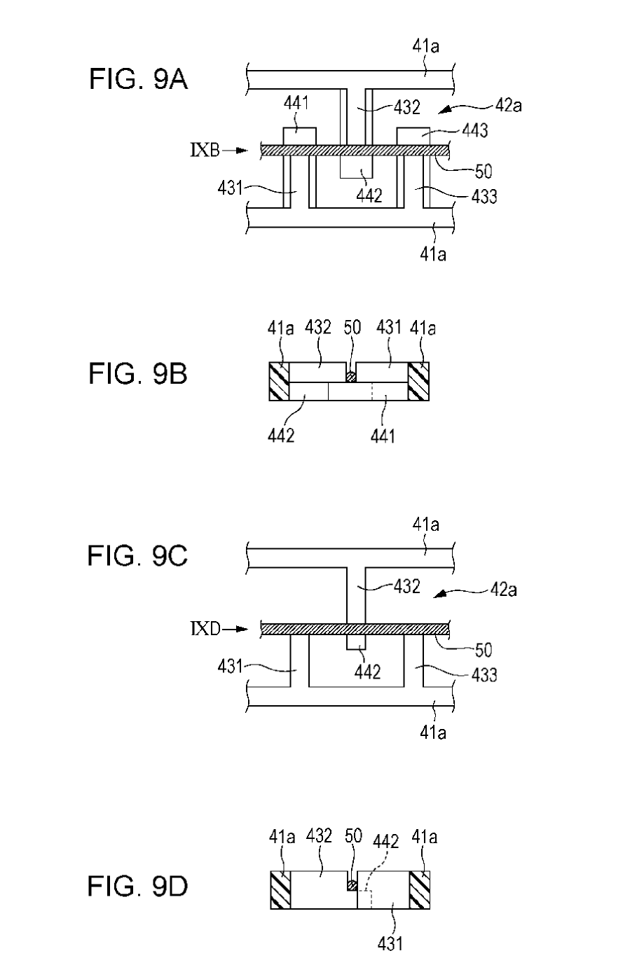

FIGS. 9A to 9D illustrate feed-cable retaining structures according to modifications that differ from the exemplary embodiment (see FIGS. 6A and 6B). FIGS. 9A and 9C illustrate two types of retaining structures. FIG. 9B illustrates the structure of FIG. 9A viewed in the direction of arrow IXB, and FIG. 9D illustrates the structure of FIG. 9C viewed in the direction of arrow IXD.

In the structure illustrated in FIG. 9A, three projecting portions 431 to 433 that extend from ribs 41a on a frame member 41 (not shown) are provided with respective adjusting portions 441 to 443 whose areas are greater than those of the three projecting portions 431 to 433. When this structure is employed, the effective length of the adjusting portions 441 to 443 in the longitudinal direction of each feed cable 50 is increased, so that an insulating gap is more reliably provided between each feed cable 50 and the bottom of a groove 42a. Therefore, vibration of the feed cable 50 may be further suppressed.

In the structure illustrated in FIG. 9C, among three projecting portions 431 to 433 that extend from ribs 41a on a frame member 41, only the projecting portion 432 at the center is provided with an adjusting portion 442, and the other projecting portions 431 and 433 are not provided with adjusting portions. Also in this structure, an insulating gap may be reliably provided between each feed cable 50 and the bottom of a groove 42a. Also in this structure, vibration of the feed cable 50 may be suppressed. The adjusting portion may be provided on any of the three projecting portions 431 to 433 to obtain this effect. Alternatively, two of the projecting portions may be provided with respective adjusting portions.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A feed-cable retaining structure that retains a feed cable that supplies electric power including an alternating current component from a power supply to a power receiving member, the feed-cable retaining structure comprising:
a support member that supports the feed cable in an insulating manner;
a plurality of retaining members that support the feed cable above the support member in an insulating manner at a plurality of predetermined positions along a longitudinal direction of the feed cable, each retaining member including two or more elements that retain the feed cable so as to sandwich the feed cable in a width direction; and
an adjusting member located at a position shifted from a middle point between the adjacent retaining members on the support member toward one of the adjacent retaining members, the position including a position of the one of the adjacent retaining members, the adjusting member adjusting an insulating gap between the feed cable and the support member by separating the feed cable from the support member.

2. The feed-cable retaining structure according to claim 1, wherein the adjusting member includes a portion that is closer to a region in which the feed cable is arranged than the elements of each retaining member are.

3. The feed-cable retaining structure according to claim 1, wherein the adjusting member is integrated with one of the retaining members.

4. The feed-cable retaining structure according to claim 2, wherein the adjusting member is integrated with one of the retaining members.

5. The feed-cable retaining structure according to claim 1, wherein each retaining member includes three or more elements that press the feed cable in different directions alternately from both sides in the width direction.

6. The feed-cable retaining structure according to claim 2, wherein each retaining member includes three or more elements that press the feed cable in different directions alternately from both sides in the width direction.

7. The feed-cable retaining structure according to claim 3, wherein each retaining member includes three or more elements that press the feed cable in different directions alternately from both sides in the width direction.

8. The feed-cable retaining structure according to claim 4, wherein each retaining member includes three or more elements that press the feed cable in different directions alternately from both sides in the width direction.

9. The feed-cable retaining structure according to claim 5,
wherein each retaining member includes three elements that retain the feed cable so as to sandwich the feed cable alternately from both sides in the width direction, and
wherein, among the retaining members, two retaining members that are adjacent to each other in the longitudinal direction of the feed cable are arranged so that a positional relationship between one of the three elements and the remaining two of the three elements is inverted between the two retaining members.

10. The feed-cable retaining structure according to claim 6,
wherein each retaining member includes three elements that retain the feed cable so as to sandwich the feed cable alternately from both sides in the width direction, and
wherein, among the retaining members, two retaining members that are adjacent to each other in the longitudinal direction of the feed cable are arranged so that a positional relationship between one of the three elements and the remaining two of the three elements is inverted between the two retaining members.

11. The feed-cable retaining structure according to claim 7,
wherein each retaining member includes three elements that retain the feed cable so as to sandwich the feed cable alternately from both sides in the width direction, and
wherein, among the retaining members, two retaining members that are adjacent to each other in the longitudinal direction of the feed cable are arranged so that a positional relationship between one of the three elements and the remaining two of the three elements is inverted between the two retaining members.

12. The feed-cable retaining structure according to claim 8,
wherein each retaining member includes three elements that retain the feed cable so as to sandwich the feed cable alternately from both sides in the width direction, and
wherein, among the retaining members, two retaining members that are adjacent to each other in the longitudinal direction of the feed cable are arranged so that a positional relationship between one of the three elements and the remaining two of the three elements is inverted between the two retaining members.

13. An image forming apparatus comprising:
an image forming unit including a power supply and a power receiving member that receives electric power from the power supply to form an image; and
the feed-cable retaining structure according to claim 1 provided between the power supply and the power receiving member.
